(19) United States
(12) Patent Application Publication
(10) Pub. No.: US 2003/0156835 A1
(43) Pub. Date: Aug. 21, 2003

(54) Viewfinder structure of image-capturing apparatus with adjustable focal length

(75) Inventor: Hsi-Hsin Loo, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Primax Electronics Ltd., Taipei (TW)

(21) Appl. No.: 10/233,808

(22) Filed: Sep. 3, 2002

(30) Foreign Application Priority Data
Feb. 21, 2002 (JP) 2002-044360

(51) Int. Cl. G03B 13/10

(52) U.S. Cl. 396/378

(57) ABSTRACT

A viewfinder of an image-capturing apparatus is provided. The image-capturing apparatus includes a first focusing device having an adjustable focal length. The viewfinder includes a second focusing device and an image-field selecting member. The second focusing device has a fixed focal length for focusing an image to be captured on an observer's eye, and the image-field selecting member is disposed downstream of the second focusing device for adjusting an area of the image viewed by the observer's eye according to a focal-length change of the first focusing device.

### FIELD OF THE INVENTION

The present invention relates to a viewfinder structure, and more particularly to a viewfinder structure of an image-capturing apparatus with an adjustable focal length.

### BACKGROUND OF THE INVENTION

Referring to FIG. 1, a typical digital still camera 1 includes a relatively small viewfinder 10 and a relatively large planar liquid crystal display 11, e.g. a thin film transistor liquid crystal display (TFTLCD), both of which can be used for view finding. By means of the viewfinder 10 or the display 11, a user can confirm the image field to be photographed. Although the screen 11 has a larger visual area than the viewfinder 10 so as to see the image field more clearly, it also consumes more power than the viewfinder 10. Therefore, when the supplied power is insufficient, the screen 11 will be turned off. At that moment, only the viewfinder 10 functions.

FIGS. 2(a) and 2(b) schematically illustrate optical systems of two typical digital still cameras, respectively. Each optical system includes an objective lens group 20, a charge coupled device (CCD) 22 and an eyepiece lens group 23. In FIG. 2(a), two light beams L1 and L2 go through the objective lens group 20 and the eyepiece lens group 23, independently. In FIG. 2(b), the optical system is similar to that shown in FIG. 2(a) except that the former further includes a beam splitter 25 for splitting the light L1 from the objective lens group 20 into two parts, one to the CCD 22 and the other to the eyepiece lens group 23. For either of the optical system, in order to obtain suitable image fields for the viewfinder in response to focus changes, a first adjusting mechanism 21 and a second adjusting mechanism 24 are provided to mechanically adjust focal lengths of the objective lens group 20 and the eyepiece lens group 23, respectively. As known, the adjusting mechanisms are consisted of a large amount of small parts so as to be complicated and inefficient in assembling. Further, since the operation of the second adjusting mechanism 24 has to synchronize with the first adjusting mechanism 21, the structure is even complicated and results in large power consumption.

### SUMMARY OF THE INVENTION

It is an object of the present invention to provide a viewfinder for use with an image-capturing apparatus with adjustable focal length, in which no mechanical adjusting mechanism for adjusting the focal length of the eyepiece lens group is required so as to overcome the above-mentioned problem.

In accordance with an aspect of the present invention, there is provided a viewfinder of an image-capturing apparatus. The image-capturing apparatus includes a first focusing device having an adjustable focal length. The viewfinder comprises a second focusing device and an image-field selecting member. The second focusing device has a fixed focal length for focusing an image to be captured on an observer's eye, and the image-field selecting member is disposed downstream of the second focusing device for adjusting an area of the image viewed by the observer's eye according to a focal-length change of the first focusing device.

In an embodiment, the first focusing device comprises at least an objective lens, and the second focusing device comprises at least an eyepiece lens. The image-field selecting member is disposed between—the second focusing device and the observer's eye.

In an embodiment, the image-field selecting member comprises a window on which a selected field of image to be realized is shown, and a mask cooperating with the window for sheltering a variable portion of the window according to different focal lengths of the first focusing device so as to exhibit the selected field of image on the unsheltered portion of the window. The mask is controlled by a controller, wherein the controller is electrically interconnected with the mask and a focal-length adjusting unit of the first focusing device. Preferably, the mask is a liquid crystal mask or an electrochromic mask.

In an embodiment, the image-field selecting member comprises a rotatable mask having thereon a plurality of apertures with different sizes and disposed between the second focusing device and the observer's eye. The rotatable mask rotates according to different focal lengths of the first focusing device so as to exhibit a selected field of image via one of the plurality of apertures.

For example, the image-capturing apparatus can be a digital still camera.

In accordance with another aspect of the present invention, there is provided a viewfinder of an image-capturing apparatus, wherein the image-capturing apparatus realizes various fields of image via a focal-length adjustable focusing device, and shows a selected field of image to be realized on the viewfinder.

In an embodiment, the viewfinder comprises a window on which the selected field of image to be realized is shown, and a mask member cooperating with the window for sheltering a variable portion of the window according to different focal lengths of the focusing device so as to exhibit the selected field of image on the unsheltered portion of the window.

In accordance with another aspect of the present invention, there is provided a viewfinder of an image-capturing apparatus. The viewfinder comprises an optical guiding member and a liquid crystal mask. The optical guiding member is used for guiding an optical image signal to an observer's eye. The liquid crystal mask is disposed between the optical guiding member and the observer's eye, and controlled to shelter a portion of the optical image signal in response to a focal-length change of the image-capturing apparatus in order to confine the area of the optical image signal viewed by the observer's eye.

In an embodiment, the optical guiding member comprises a lens.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a digital still camera according to prior art;

FIGS. 2(a) and 2(b) schematically illustrate optical systems of two digital still cameras according to prior art;

FIGS. 3(a) and 3(b) schematically illustrate optical systems of two digital still cameras according to the present invention;

FIGS. 4(a) to 4(d) are schematic views illustrating various operational modes of an image-field selecting member for sheltering a viewfinder according to a first preferred embodiment of the present invention;

FIGS. 5(a) to 5(d) are schematic views illustrating various operational modes of an image-field selecting member for sheltering a viewfinder according to a second preferred embodiment of the present invention;

FIGS. 6(a) to 6(d) are schematic views illustrating various operational modes of an image-field selecting member for sheltering a viewfinder according to a third preferred embodiment of the present invention; and

FIG. 7 is a schematic view illustrating an image-field selecting member performing various operational modes for sheltering a viewfinder according to a fourth preferred embodiment of the present invention.

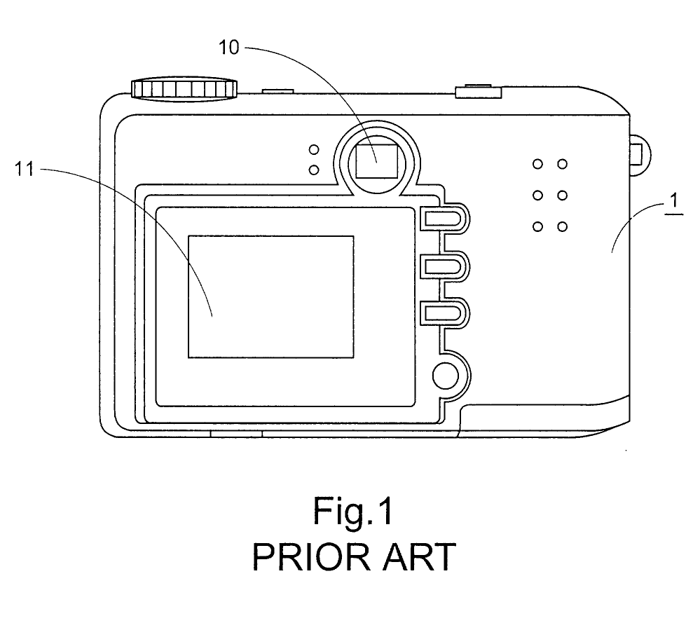

### DETAILED DESCRIPTION OF THE PREFERRED EMBODIMENT

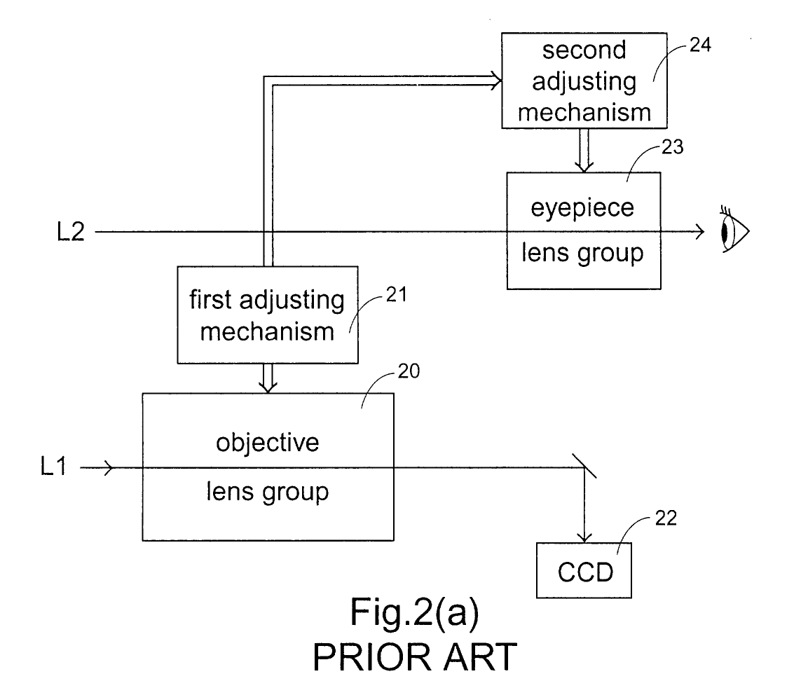

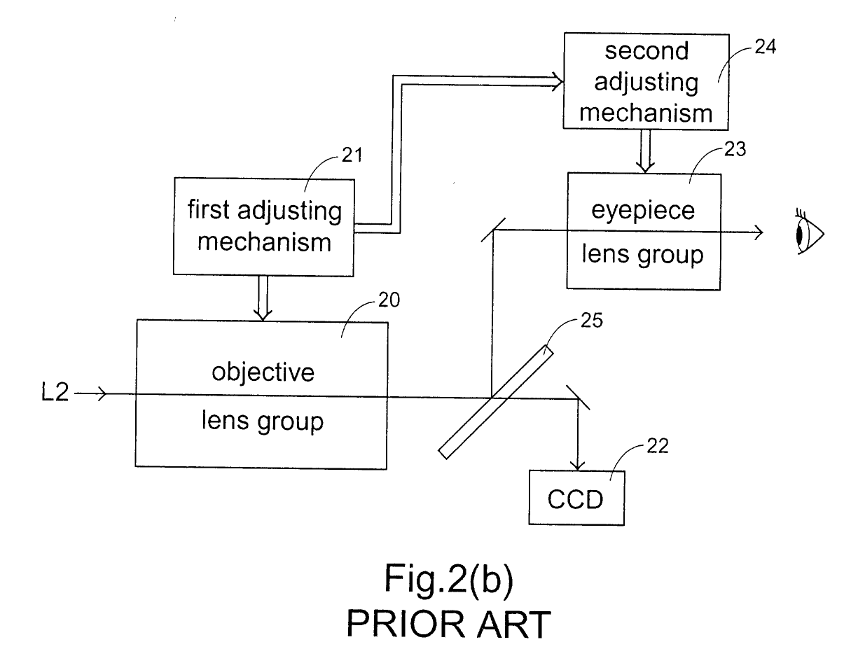

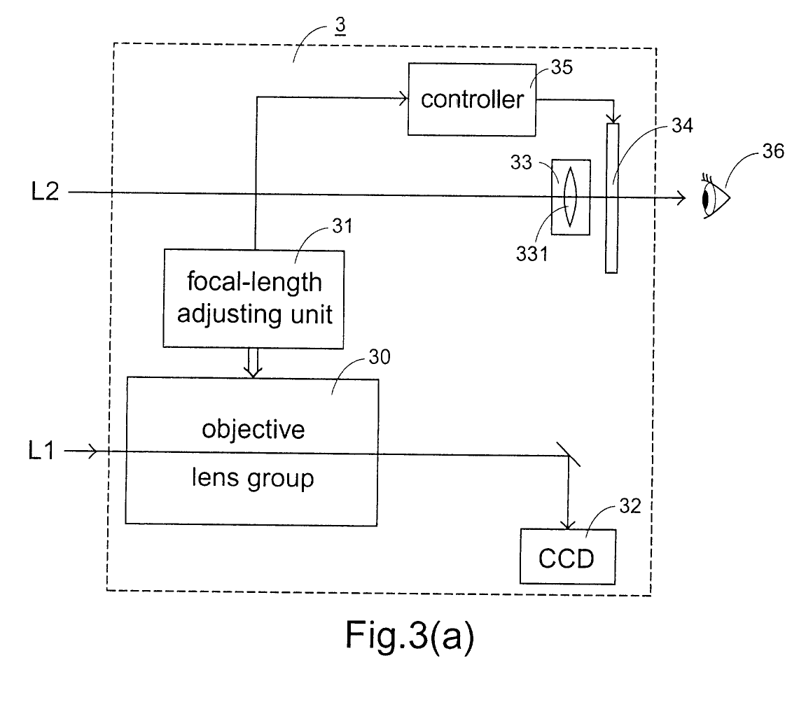

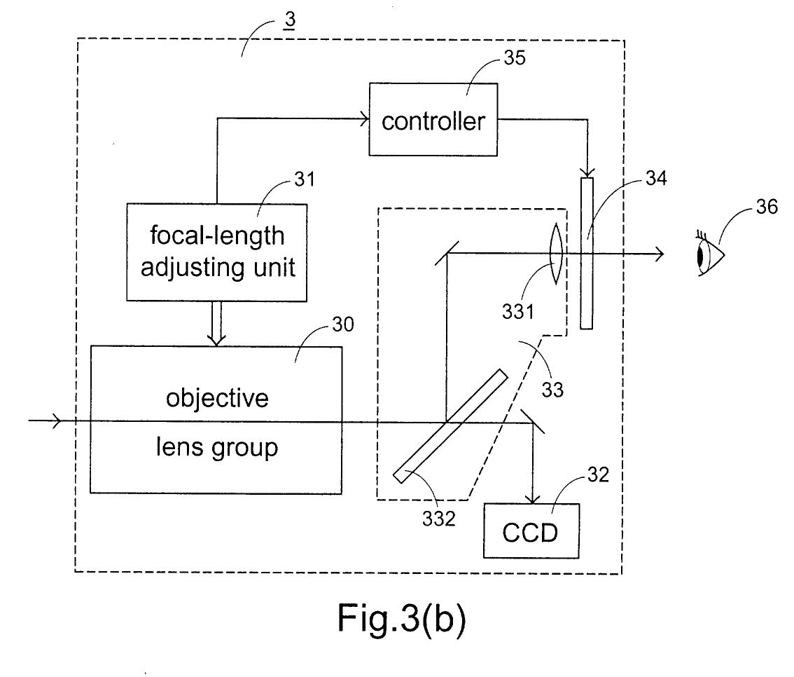

FIGS. 3(a) and 3(b) are functional block diagrams illustrating optical system of two digital still cameras according to the present invention. The optical systems of FIGS. 3(a) and 3(b) are similar to those of FIGS. 2(a) and 2(b), respectively. The complicated adjusting mechanism for mechanically adjusting the focal length of the eyepiece lens group, however, is omitted in the present optical systems. Each optical system of the digital still camera 3 includes an objective lens group 30, a charge coupled device (CCD) 32 and an optical guiding member 33. The optical guiding member 33 in FIG. 3(a) comprises an eyepiece lens group 331, while the optical guiding member 33 in FIG. 3(b) further comprises a beam splitter 332 in addition to an eyepiece lens group 331.

In addition, an image-field selecting member 34 is mounted as a part of the viewfinder, and disposed beside the optical guiding member 33. The objective lens group 30 has an adjustable focal length adjusted by a focal-length adjusting unit 31 which can be any suitable mechanism used in the prior art. In accordance with the present invention, the eyepiece lens group 331 has a fixed focal length for focusing an image to be captured on an observer's eye 36. The image-field selecting member 34 disposed downstream of the eyepiece lens group 331, especially between the eyepiece lens group 331 and the observer's eye 36, adjusts an area of the image viewed by the observer's eye 36 according to a focal-length change of the objective lens group 30 under the control of a controller 35. The controller 35 is electrically interconnected with the image-field selecting member 34 and focal-length adjusting unit 31 so as to dynamically adjust the viewing area by the observer in response to the focal-length change of the objective lens. The viewing area adjustment will be illustrated in more details hereinafter.

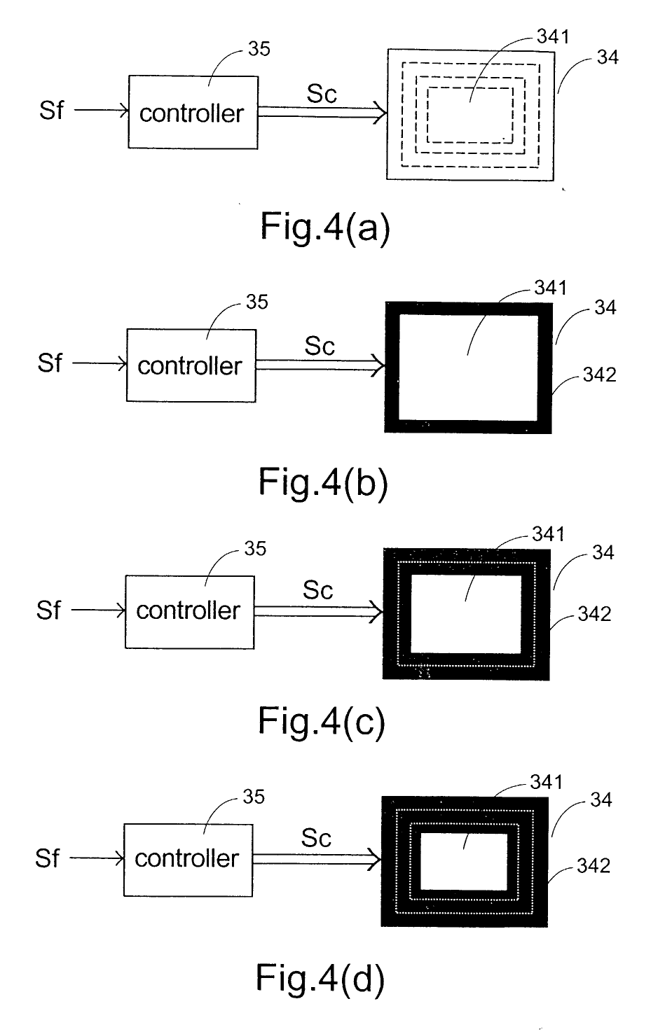

Please refer to FIGS. 4(a) to 4(d). The image-field selecting member 34 according to a first preferred embodiment of the present invention comprises a window 341 and a liquid crystal mask 342. A focal change signal Sf generated according to different focal lengths of the objective lens group 30 is transmitted to the controller 35, and a control signal Sc is generated to control the liquid crystal mask 342 accordingly. The liquid crystal mask 342 cooperates with the window 341 for sheltering a variable portion of the window 341 in response to the control signal Sc so as to exhibit a selected field of image on the unsheltered portion of the window 341. It is known to a person skilled in the art that the focal change signal Sf can be any suitable type of signal representing a focal change of the focal-length adjusting unit 31, for example a resistance change of a variable resistor, a step value change of a step motor or a pulse signal of a light chopper. For the change from FIGS. 4(b) to 4(d) sequentially, an increasing area of the window 341 is sheltered by the liquid crystal mask 342 with an increase of the focal length. Thus, a selected field of image on the unsheltered portion of the window is adjusted in this manner until the selected field corresponds to the field to be actually photographed. In this embodiment, the sheltering operation of the image-field selecting member 34 is achieved due to the light-transmittance-changeable feature of the liquid crystal mask 342, that is well known to those skilled in the art and is not redundantly described herein.

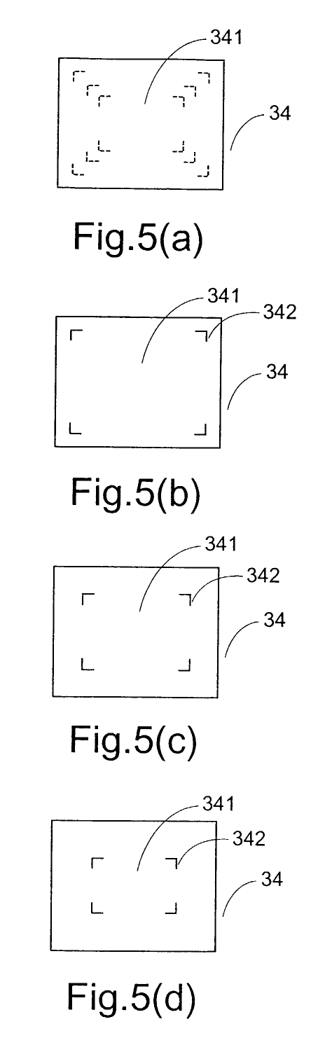

Referring to FIGS. 5(a)-5(d). The image-field selecting member 34 according to a second preferred embodiment of the present invention also comprises a window 341 and a liquid crystal mask 342. The liquid crystal mask 342 cooperates with the window 341 for sheltering a variable portion of the window 341. In this embodiment, the sheltered portions comprise some marks together confining the area of the image viewed by a user. With an increase of the focal length, the confined area is reduced.

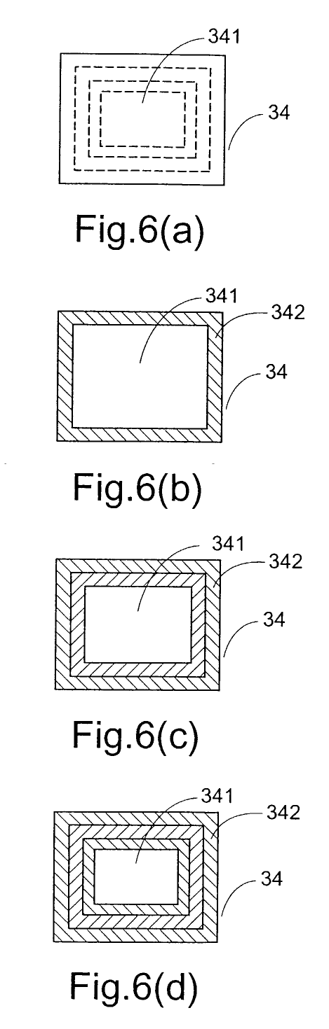

Referring to FIGS. 6(a)-6(d). The image-field selecting member 34 according to a third preferred embodiment of the present invention also comprises a window 341 and a liquid crystal mask 342. The liquid crystal mask 342 cooperates with the window 341 for sheltering a variable portion of the window 341. In this embodiment, the sheltered portions are identified by color change. With an increase of the focal length, the unsheltered portion is reduced. It is of course that the liquid crystal mask 342 can be replaced with an electrochromic mask to achieve the same purpose of color change. The principle of an electrochromic element is known, and for example described in U.S. Pat. No. 6,211,994.

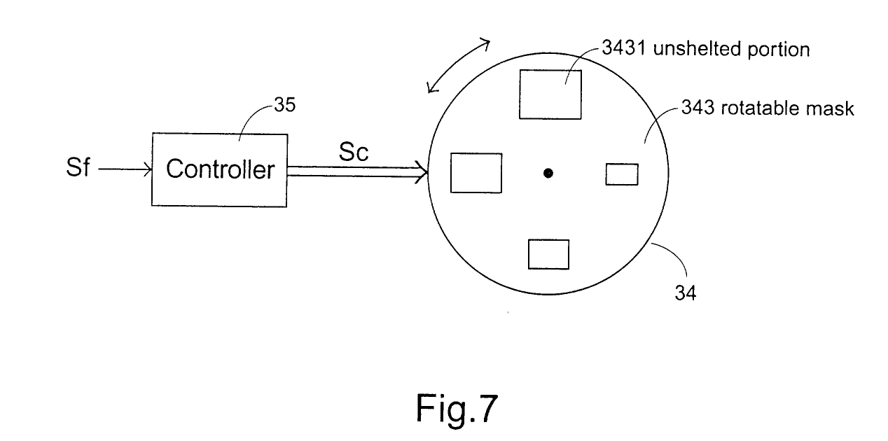

The image-field selecting member 34 according to a fourth preferred embodiment of the present invention is shown in FIG. 7. The image-field selecting member 34 comprises a rotatable mask 343 having thereon a plurality of apertures 3431 (unsheltered portion) with different sizes. The rotatable mask 343 rotates according to different focal lengths of the objective lens group 30 so as to exhibit a selected field of image via one of the plurality of apertures 3431.

Since in the present invention the complicated second adjusting mechanism 24 in the prior art is omitted, it is advantageous in reduction of power consumption and improvement of cost-effectiveness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A viewfinder of an image-capturing apparatus, said image-capturing apparatus including a first focusing device having an adjustable focal length, said viewfinder comprising:
a second focusing device of a fixed focal length for focusing an image to be captured on an observer's eye; and
an image-field selecting member disposed downstream of said second focusing device for adjusting an area of said image viewed by said observer's eye according to a focal-length change of said first focusing device.

2. The viewfinder according to claim 1 wherein said first focusing device comprises at least an objective lens.

3. The viewfinder according to claim 1 wherein said second focusing device comprises at least an eyepiece lens.

4. The viewfinder according to claim 1 wherein said image-field selecting member is disposed between said second focusing device and said observer's eye.

5. The viewfinder according to claim 1 wherein said image-field selecting member comprises:
a window on which a selected field of image to be realized is shown; and
a mask cooperating with said window for sheltering a variable portion of said window according to different focal lengths of said first focusing device so as to exhibit said selected field of image on the unsheltered portion of said window.

6. The viewfinder according to claim 5 wherein said mask is controlled by a controller, said controller being electrically interconnected with said mask and a focal-length adjusting unit of said first focusing device.

7. The viewfinder according to claim 5 wherein said mask is one of a liquid crystal mask and an electrochromic mask.

8. The viewfinder according to claim 1 wherein said image-field selecting member comprises a rotatable mask having thereon a plurality of apertures with different sizes and disposed between said second focusing device and said observer's eye, wherein said rotatable mask rotates according to different focal lengths of said first focusing device so as to exhibit a selected field of image via one of said plurality of apertures.

9. The viewfinder according to claim 1 wherein said image-capturing apparatus is a digital still camera.

10. A viewfinder of an image-capturing apparatus, said image-capturing apparatus realizing various fields of image via a focal-length adjustable focusing device, and showing a selected field of image to be realized on said viewfinder, said viewfinder comprising:
a window on which said selected field of image to be realized is shown; and
a mask member cooperating with said window for sheltering a variable portion of said window according to different focal lengths of said focusing device so as to exhibit said selected field of image on the unsheltered portion of said window.

11. The viewfinder according to claim 10 wherein said mask member is controlled by a controller, said controller being electrically interconnected with said mask member and said focal-length adjustable focusing device.

12. The viewfinder according to claim 10 wherein said mask member is one of a liquid crystal mask and an electrochromic mask.

13. The viewfinder according to claim 13 wherein said image-capturing apparatus is a digital still camera.

14. A viewfinder of an image-capturing apparatus comprising:
an optical guiding member for guiding an optical image signal to an observer's eye; and
a liquid crystal mask disposed between said optical guiding member and said observer's eye, and controlled to shelter a portion of said optical image signal in response to a focal-length change of said image-capturing apparatus in order to confine the area of said optical image signal viewed by said observer's eye.

15. The viewfinder according to claim 14 wherein said optical guiding member comprises a lens.

16. The viewfinder according to claim 14 wherein said image-capturing apparatus is a digital still camera.
